(19) United States
(12) Patent Application Publication
(10) Pub. No.: US 2024/0253678 A1
(43) Pub. Date: Aug. 1, 2024

(54) PLATFORM CART

(71) Applicant: OLYMPIA TOOLS INTERNATIONAL, INC., Covina, CA (US)

(72) Inventor: Jonathan S. BECKWITH, Durham, NC (US)

(21) Appl. No.: 18/102,513

(22) Filed: Jan. 27, 2023

(51) Int. Cl. B62B 3/02; B62B 5/06

(52) U.S. Cl. CPC B62B 3/02; B62B 5/067; B62B 2205/10; B62B 2301/04; B62B 2301/05

(57) ABSTRACT

A platform cart includes a deck having a first plurality of caster sockets and a second plurality of caster sockets formed in a lower surface thereof. A handle is pivotally attached to the deck. A plurality of casters are provided. Each caster is selectively positionable in one of the first plurality of caster sockets and in one of the second plurality of caster sockets. When each of the plurality of casters are respectively positioned in each of the first plurality of caster sockets, the plurality of casters extend from the lower surface of the deck to provide rolling support for the platform cart. When each of the plurality of casters are respectively positioned in each of the second plurality of caster sockets, the plurality of casters do not extend from the lower surface of the deck.

### BACKGROUND

### Field

Embodiments of the present disclosure generally relate to a platform cart.

### Description of the Related Art

In U.S. Pat. No. 6,024,376 issued to Golichowski et al., the contents of which are hereby incorporated by reference, a platform truck with a multi-positionable handle is disclosed. The handle of the Golichowski platform truck can fold to a horizontal position so that the platform truck can be used as a handleless dolly and be stored under a table or hung on a wall. The Golichowski platform truck also includes caster assemblies for mobility. The rear casters are positionable in two different caster sockets, depending on whether the user prefers the rear casters to swivel or not swivel.

In U.S. Pat. No. 8,979,098 issued to Wang et al., the contents of which are hereby incorporated by reference, a collapsible platform truck is disclosed. The Wang platform truck includes wheels interconnected with a handle via gear members and related connecting structures. As the handle is rotated towards a horizontal position, the gear members and connecting structures cause the wheels to rotate to a folded position.

However, there is a need for an improved platform cart.

### SUMMARY

Embodiments of the present disclosure generally relate to a platform cart.

According to an embodiment, the platform cart may include a deck having a first plurality of caster sockets and a second plurality of caster sockets formed in a lower surface thereof. A handle may be pivotally attached to the deck. A plurality of casters may be provided. Each caster may be selectively positionable in one of the first plurality of caster sockets and in one of the second plurality of caster sockets. When each of the plurality of casters are respectively positioned in each of the first plurality of caster sockets, the plurality of casters may extend from the lower surface of the deck to provide rolling support for the platform cart. When each of the plurality of casters are respectively positioned in each of the second plurality of caster sockets, the plurality of casters may not extend from the lower surface of the deck.

According to an aspect of the embodiment, when each of the plurality of casters are respectively positioned in each of the first plurality of caster sockets, a stem of each of the plurality of casters may be oriented parallel to the lower surface of the deck.

According to another aspect of the embodiment, the deck may include a first recess in a first side of the deck, a second recess in a second side of the deck opposite the first side, and a third recess in a front side of the deck.

According to another aspect of the embodiment, the handle may be configured to pivot relative to the deck between a fold-flat position and at least one of a push position and a pull position.

According to another aspect of the embodiment, when the handle is in the fold flat position, the handle may: span the first recess to provide a first carrying point, span the second recess to provide a second carrying point, and span the third recess to provide a third carrying point.

According to another aspect of the embodiment, when the handle is in the fold flat position and when each of the plurality of casters are respectively positioned in each of the second plurality of caster sockets, a thickness of the entire platform cart may be substantially the same as a thickness of the deck taken separately.

According to another aspect of the embodiment, the deck may include a channel on each of the first and second sides of the deck. The channel may be configured to receive the handle in the fold flat position so that, when the handle is in the fold flat position, a width of the entire platform cart is substantially the same as a width of the deck taken separately.

According to another aspect of the embodiment, when each of the plurality of casters are respectively positioned in each of the first plurality of caster sockets, a line between a rear side of the deck and an outer circumference of a wheel of one or more of the casters closest to the rear side may form a substantially right angle with an upper surface of the deck opposite the lower surface.

According to another aspect of the embodiment, the handle may be configured to pivot relative to the deck between a fold-flat position and at least one of a push position and a pull position. When each of the plurality of casters are respectively positioned in each of the first plurality of caster sockets and the handle is in the fold flat position, the platform cart may be stably stored in a substantially vertical position on an external surface.

According to another aspect of the embodiment, each of the plurality of casters may be pivoting casters.

According to another aspect of the embodiment, when the platform cart is stored in the substantially vertical position, the rear side of the deck and the outer circumference of the wheel of the one or more of the casters closest to the rear side may support the platform cart in the substantially vertical position.

According to another aspect of the embodiment, the plurality of casters may each be positioned and removed from each of the first plurality of caster sockets and each of the second plurality of caster sockets by a user without tools.

According to an alternative embodiment, the platform cart may include a deck having a first plurality of caster sockets and a second plurality of caster sockets formed in a lower surface thereof. A handle may be pivotally attached to the deck. A reinforcing plate may be positioned at a pivot point where the handle pivots relative to the deck. The reinforcing plate may be configured to reinforce the deck from breakage due to force applied to the handle. A plurality of casters may be provided. Each caster may be selectively positionable in one of the first plurality of caster sockets and in one of the second plurality of caster sockets.

According to the alternative embodiment, the handle may be pivotally attached to the deck with a primary pin. The reinforcing plate may be disposed in a slot formed in the deck and is secured to the deck with the primary pin and a retaining pin.

According to another alternative embodiment, the platform cart may include a deck having a first plurality of caster sockets and a second plurality of caster sockets formed in a lower surface thereof. A handle may be pivotally attached to the deck with a pivot pin. A plurality of casters may be provided. Each caster may be selectively positionable in one of the first plurality of caster sockets and in one of the second plurality of caster sockets. An effective length of the handle from the pivot pin to a front end of the handle may be longer by about 15% or more than a corresponding length of the deck from the pivot pin to a front side of the deck.

According to another alternative embodiment, the platform cart may include a deck having a first plurality of caster sockets and a second plurality of caster sockets formed in a lower surface thereof. A handle may be pivotally attached to the deck. A plurality of casters may be provided. Each caster may be selectively positionable in one of the first plurality of caster sockets and in one of the second plurality of caster sockets. When each of the plurality of casters are respectively positioned in each of the first plurality of caster sockets, a line between a rear side of the deck and an outer circumference of a wheel of one or more of the casters closest to the rear side may form a substantially right angle with an upper surface of the deck opposite the lower surface.

According to an aspect of the alternative embodiment, the handle may be configured to pivot relative to the deck between a fold-flat position and at least one of a push position and a pull position.

According to another aspect of the alternative embodiment, when each of the plurality of casters are respectively positioned in each of the first plurality of caster sockets and the handle is in the fold flat position, the platform cart may be stably stored in a substantially vertical position on an external surface.

According to another aspect of the alternative embodiment, each of the plurality of casters may be pivoting casters.

According to another aspect of the alternative embodiment, when the platform cart is stored in the substantially vertical position, the rear side of the deck and the outer circumference of the wheel of the one or more of the casters closest to the rear side may support the platform cart in the substantially vertical position.

According to another aspect of the alternative embodiment, when each of the plurality of casters are respectively positioned in each of the first plurality of caster sockets, a stem of each of the plurality of casters may be oriented parallel to the lower surface of the deck.

According to another aspect of the alternative embodiment, the deck may include a first recess in a first side of the deck, a second recess in a second side of the deck opposite the first side, and a third recess in a front side of the deck.

According to another aspect of the alternative embodiment, the handle may be configured to pivot relative to the deck between a fold-flat position and at least one of a push position and a pull position.

According to another aspect of the alternative embodiment, when the handle is in the fold flat position: the handle may: span the first recess to provide a first carrying point, span the second recess to provide a second carrying point, and span the third recess to provide a third carrying point.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a top perspective view of a platform cart with a handle thereof in a push configuration according to an exemplary embodiment of the present disclosure;

FIG. 2 is a bottom perspective view of the platform cart;

FIG. 3 is an exploded top perspective view of the platform cart;

FIG. 4A is a top perspective view of the platform cart in a fold flat configuration;

FIG. 4B is a top view of the platform cart in the fold flat configuration;

FIG. 4C is a detail view of a portion of the platform cart as indicated in FIG. 4A;

FIG. 4D is a cross-sectional view of a portion of the platform cart along the line indicated in FIG. 4B;

FIG. 5A is a bottom perspective view of the platform cart in a flat storage configuration;

FIG. 5B is a bottom view of the platform cart in the flat storage configuration

FIG. 5C is a detail bottom perspective view of a portion of the platform cart;

FIG. 5D is a detail cross-section view of a portion of the platform cart along the line indicated in FIG. 5B;

FIG. 5E is a detail cross-section view of a portion of the platform cart along the line indicated in FIG. 5B;

FIG. 6 is a side view of the platform cart in the push configuration with phantom lines indicating a pull configuration;

FIG. 7A is a detail side view of a portion of the platform cart in the fold flat configuration;

FIG. 7B is a detail side view of a portion of the platform cart in the push configuration;

FIG. 7C is a detail side view of a portion of the platform cart in the pull configuration;

FIG. 8 is a side view of the platform cart in the fold flat configuration and in a zero-tilt position;

FIG. 9 is a detail perspective view of a portion of the platform cart;

FIG. 10 is a detail cross-section view of a portion of the platform cart along the line indicated in FIG. 5B;

FIG. 11 is a detail cross-section view of a portion of the platform cart, with some elements omitted, along the line indicated in FIG. 5B;

FIG. 12 is a detail cross-section view of a portion of the platform cart along the line indicated in FIG. 5B; and

FIG. 13 is a detail cross-section view of a portion of the platform cart along the line indicated in FIG. 5B.

### DRAWING REFERENCE NUMERALS

100—platform cart
102—deck
102A—first side
102B—second side
102C—front side
102D—rear side
102E—channel
103—latch
103A—ridge
104—handle
106—caster
106A—caster stem
106B—caster frame
106C—caster wheel
108A—first recess
108B—second recess
108C—front recess
110—upper surface
112—lower surface
114—rib
116—first caster socket
118—second caster socket
118A—jaw member
120—bracket
121—primary pin
121A—retaining pin
122—pocket
124A—first carrying point
124B—second carrying point
124C—third carrying point
125—exterior surface
126—aperture
126A—first support surface
126B—second support surface
126C—third support surface
128—reinforcing plate
128A—retaining pin aperture
128B—primary pin aperture
129—plate slot
130—friction washer
132—retaining slot

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to a platform cart, more particularly, embodiments relating to a platform cart having a multi-position handle, that can be vertically stored without support, and can be readily arranged into a compact flat-storage configuration.

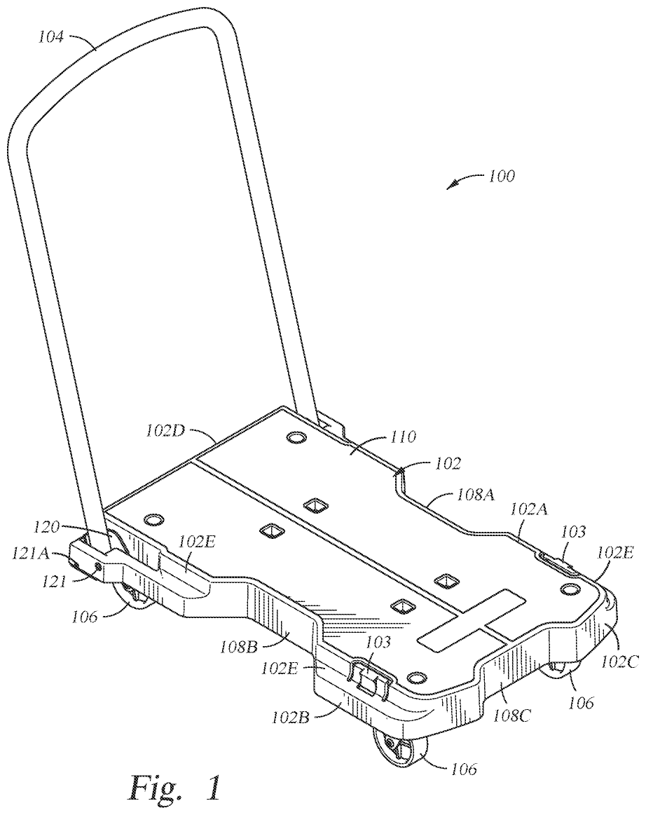

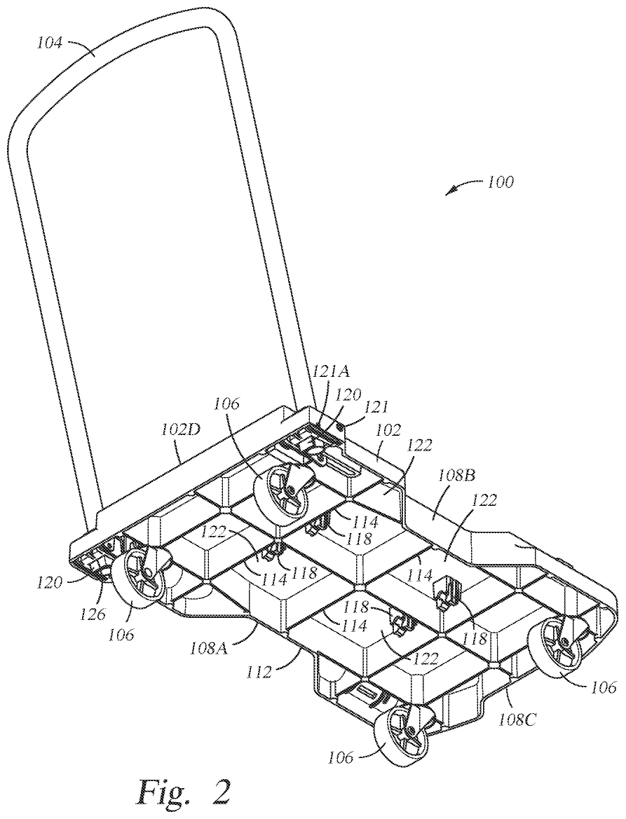

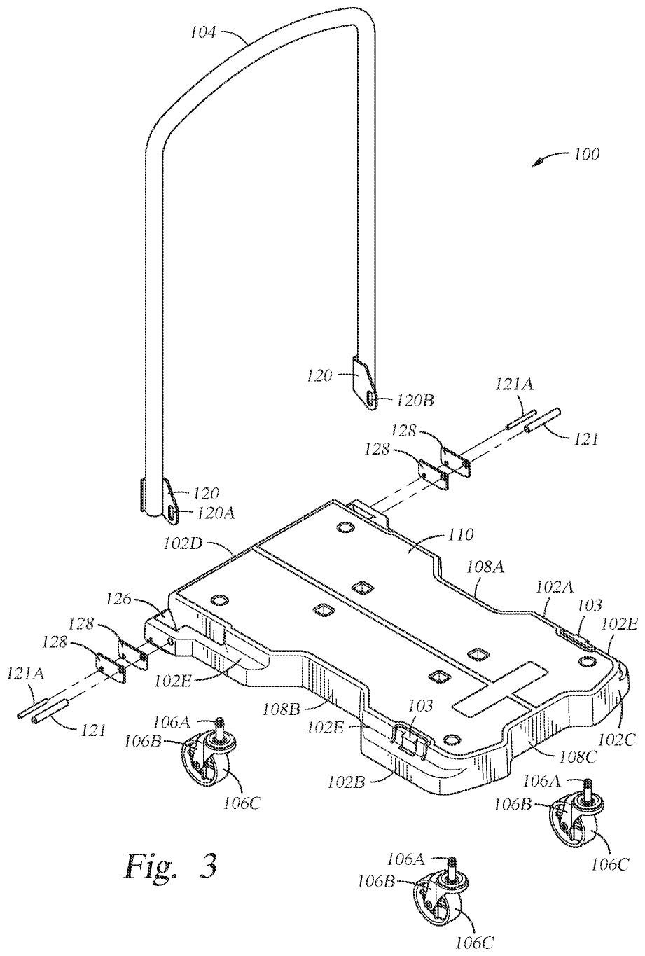

FIGS. 1 and 2 illustrate an example platform cart 100 according to an embodiment. FIG. 3 illustrates an exploded view of the platform cart 100. The platform cart 100 includes a deck 102 and a handle 104 attached to the deck 102. As will be described further below, the handle 104 is pivotally movable relative to the deck 102 between a plurality of positions.

The deck 102 may be fabricated from any suitable material. According to some embodiments, the material and process used for manufacturing the deck 102 may be selected to optimize certain desired properties such as high strength, low weight, and low cost. For example, the deck 102 may be fabricated using injection molding with a plastic resin such as polypropylene.

The deck 102 includes a first side 102A, a second side 102B, a front side 102C, and a rear side 102D. The first side 102A includes a channel 102E and a first recess 108A. The second side 102B also includes channel 102E and a second recess 108B. A latch 103 is formed in each channel 102E.

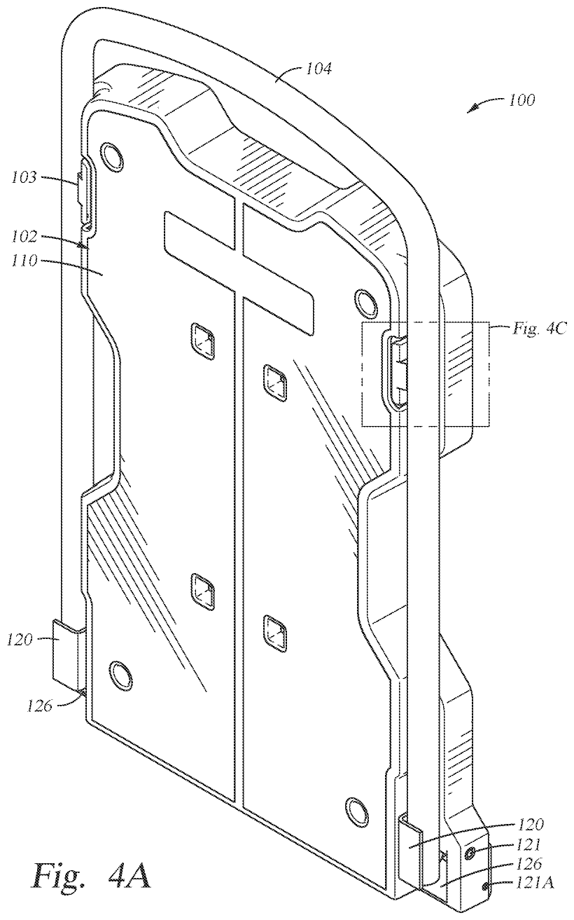

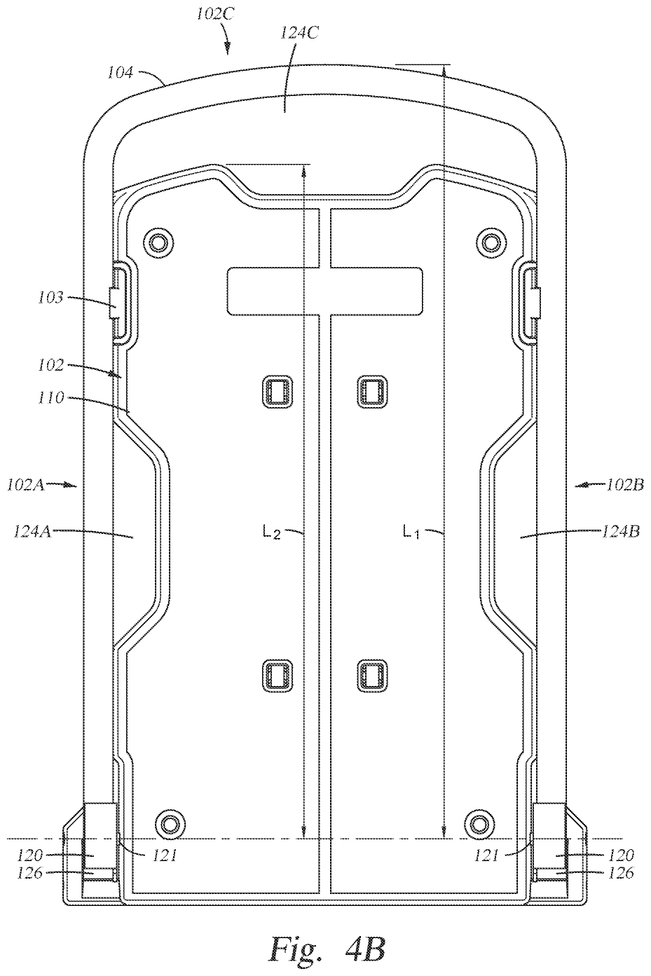

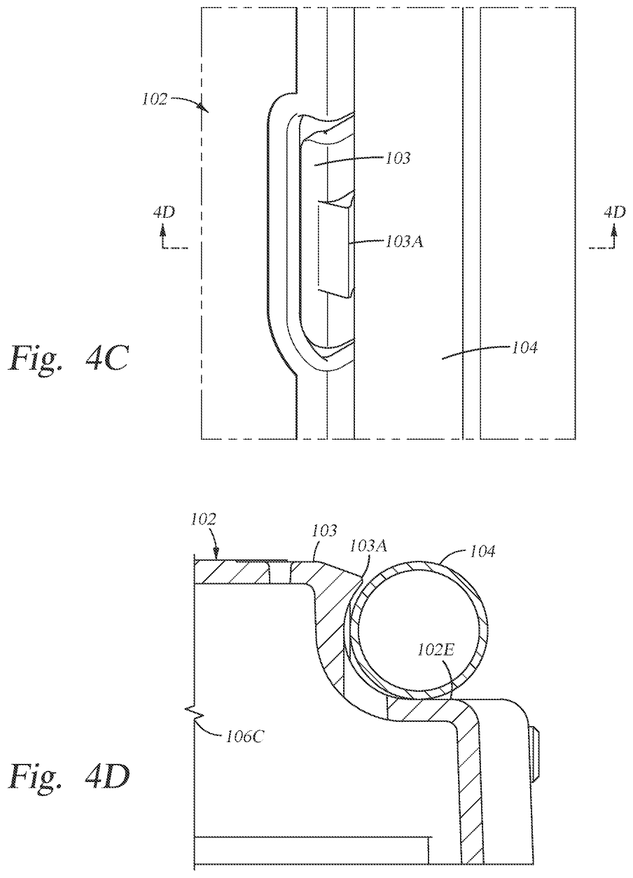

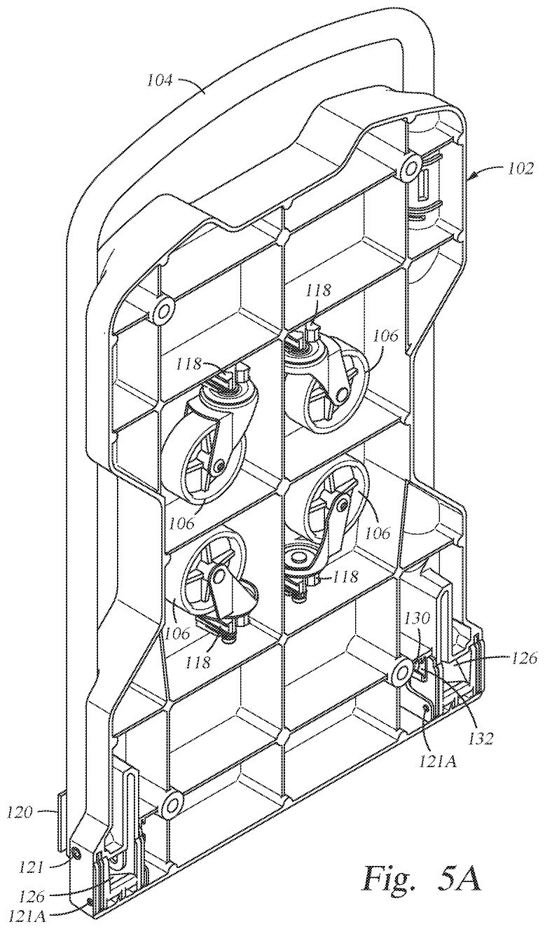

FIGS. 4A and 4B illustrate the platform cart 100 in a fold-flat position. The channel 102E is shaped to receive the handle 104 when the handle 104 is in the fold-flat position, as will be described further below. When the handle 104 is in the fold-flat position, the latch 103 releasable secures the handle 104 in place.

The latch 103 is shown in the detailed perspective view of FIG. 4C (taken as indicated from FIG. 4A). The latch 103 and the handle 104 are shown in the cross-section detailed view of FIG. 4D (taken as indicated from FIG. 4C). The latch 103 may be formed by a flexible U-shaped cutout with a ridge 103A formed thereon. As the handle 104 is moved towards the fold-flat position, the handle 104 engages the ridge 103A, causing the latch 103 to flex inward. When the handle is fully seated in the channel 102E, the ridge 103A returns and engages a top surface of the handle 104, thereby securing the handle 103A in place. To move the handle 104 out of the fold-flat position, the user can flex the latch 103 inward by, for example, depressing the ridge 103A. When the ridge 103A is clear of the handle 104, the handle 104 is free to be moved out of the fold-flat position.

According to an embodiment, the handle 104 may be generally U-shaped, and may include a pair brackets 120 secured to the two ends of the handle 104. The handle 104 may be formed from, for example, a tubular member. The handle 104 may be pivotally attached to the deck 102 with a primary pin 121 extending through slot 120A in bracket 120 at each end of the handle 104, for example. As will be discussed further below, the primary pin 121 also extends through a pair of reinforcing plates 128. Additionally, a retaining pin 121A helps secure the reinforcing plates 128 in place relative to the deck 102.

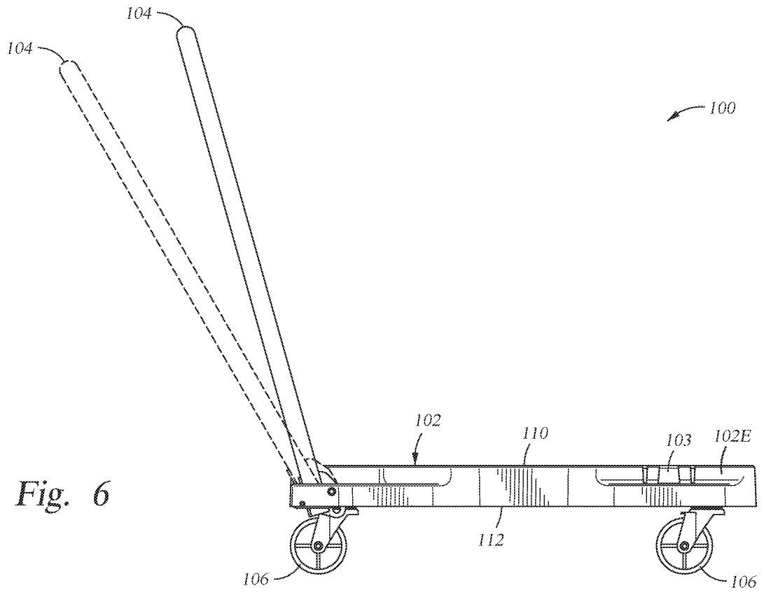

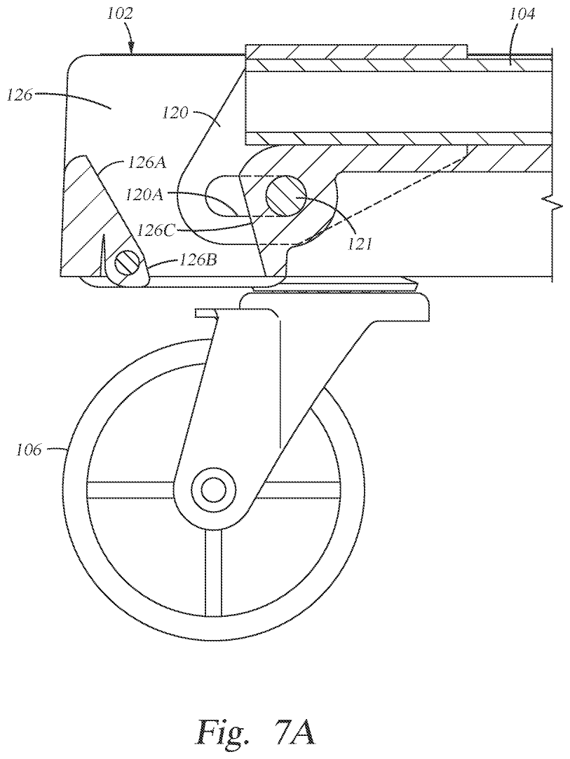

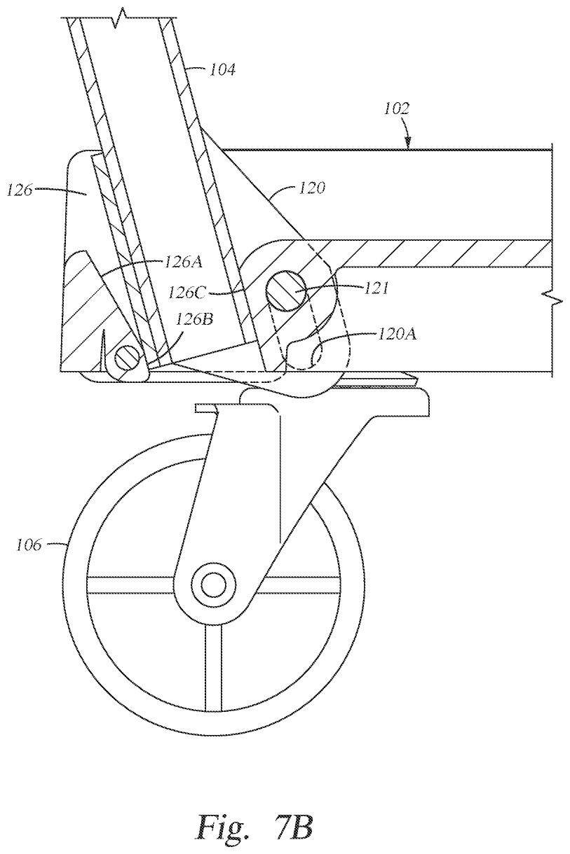

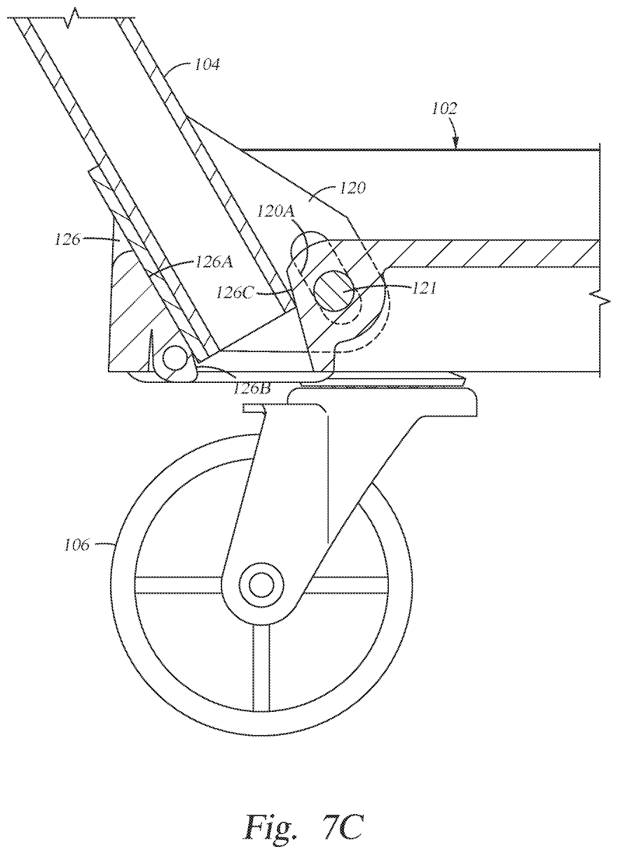

The handle 104 can pivot relative to the deck 102 into different positions. For example, according to an embodiment the handle 104 may be moved into the fold-flat position (shown in FIGS. 4A, 4B, 7A), a push position (shown in FIG. 1, in solid lines in FIG. 6, FIG. 4B), and a pull position (shown in phantom lines in FIG. 6, FIG. 4C). For example, the fold-flat position may be one in which the handle 104 is angled at zero degrees relative to an upper surface 110 of the deck 102. The push position may be one in which the handle 104 is angled at 105 degrees relative to the upper surface 110 of the deck 102. The push position may be optimized for ergonomic comfort when pushing the platform cart 100. The pull position may be one in which the handle 104 is angled at 120 degrees relative to the upper surface 110 of the deck 102. The pull position may be optimized for ergonomic comfort when pulling the platform cart 100.

The handle 104 includes handle ends 104A. According to an embodiment and as can be seen in FIGS. 7A, 7B, and 7C, the handle ends 104A are respectively positioned in a pair of apertures 126 formed in the deck 102, at the rear side 102D and adjacent the channels 102E on each of the first and second sides 102A, 102B. According to an embodiment, the apertures 126 extend through the lower surface 112 of the deck 102. Alternatively, the handle ends 104A may be respectively positioned in a pair of depressions (not shown), similar to the apertures 126 but not necessarily extending through the lower surface 112 of the deck 102.

Each aperture 126 may include a first support surface 126A, a second support surface 126B, and a third support surface 126C. The first support surface 126A is angled relative to the deck 102 at the same angle as the handle 104 when the handle 104 is in the pull position. Accordingly, when the handle 104 is in the pull position, the first support surface 126A supports the handle ends 104A at the appropriate angle, as seen in FIG. 7C. Additionally, the handle ends 104A may have a point of contact with the third support surface 126C when the handle 104 is in the pull position, thereby supporting the handle ends 104A when, for example, a pushing force is applied to the cart 100 via the handle 104.

The second support surface 126B is angled relative to the deck 102 at the same angle as the handle 104 with the handle 104 is in the push position. Accordingly, when the handle 104 is in the push position, the second support surface 126B supports the handle ends 104A at the appropriate angle, as seen in FIG. 7B. In this position, the third support surface 126C opposite the second support surface 126B also supports the handle ends 104A when, for example, a pushing force is applied to the cart 100 via the handle 104. The handle 104 can be moved between the different positions by applying an appropriate rotational and/or translational force to move the bracket 120 relative to the primary pin 121 disposed in slot 120A.

When the handle 104 is in the fold-flat position as illustrated, for example, in FIGS. 4A, 4B, the handle 104 spans each of the recesses 108A, 108B, 108C. Accordingly, the recesses 108A, 108B, 108C and the handle 104 define three separate carrying points 124A, 124B, 124C, as indicated in FIG. 4B. Accordingly, a user may easily carry the platform cart 100 using one or more of the carrying points 124A, 124B, 124C as may be convenient.

The platform cart 100 also includes a plurality of casters 106. In the disclosed embodiment, the platform cart 100 includes four casters 106, each having a stem 106A, a frame 106B, and a wheel 106C.

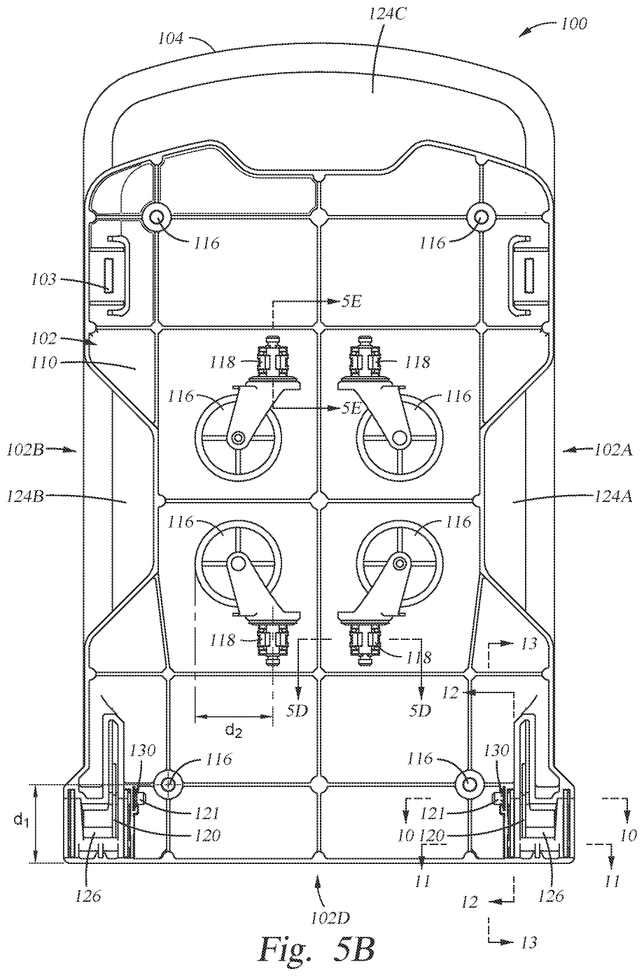

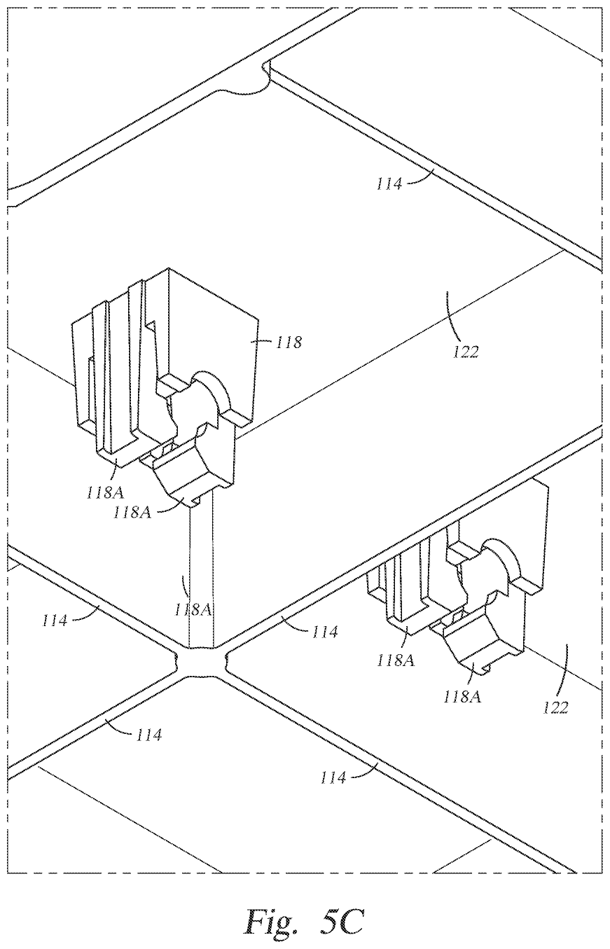

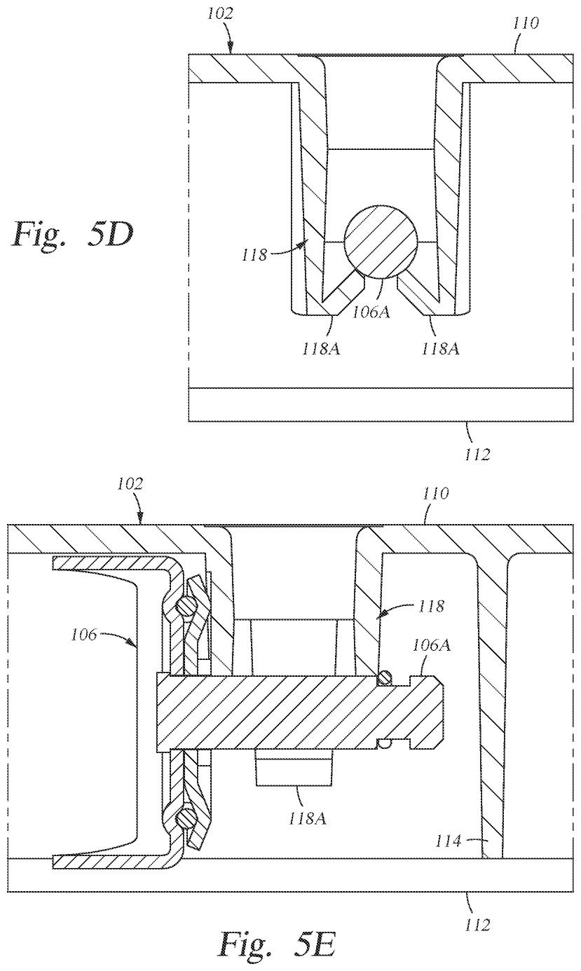

The deck 102 includes the upper surface 110 (shown in FIG. 1) and a lower surface 112 (shown in FIG. 2). The upper surface 110 may include a textured finish for secure placement of a load thereon. The lower surface 112 may include one or more ribs 115 to provide structural load bearing support for deck 102. The lower surface 112 of the deck 102 also includes first caster sockets 116 (see FIG. 5A) and second caster sockets 118.

The first caster sockets 116 are oriented in a direction perpendicular to the plane generally defined by the lower surface 112. The stem 106A of each caster 106 can be inserted into a corresponding one of the first caster sockets 116 so that the casters 106 are pivotally secured to the deck 102 and extending out of the lower surface 112. This load-ready configuration shown, for example, in FIGS. 1 and 2 allows the platform cart 100 to be used to support and transport a load as desired by a user. The load-ready configuration of the platform cart 100 (i.e., with the casters 106 pivotally secured to the deck 102) can be used for supporting and transporting a load, regardless of which of the plurality of positions the handle 104 has relative to the deck 102.

The casters 106 may be conventional casters configured to be readily inserted into and removed from the first and second caster sockets 116, 118. The first and second caster sockets 116, 118 are configured to sufficiently secure the casters 106 to the deck 102 as described herein, while also allowing a user to move the casters 106 between the respective caster sockets 116, 118 depending on the desired configuration. It is contemplated that the casters 106 may be moved between the respective caster sockets 116, 118 hundreds of times during the lifetime of the platform cart 100, potentially more for certain use cases or applications. Accordingly, one skilled in the art would appreciate that appropriate materials, fitment, and the like can be selected for the casters 106 and the first and second caster sockets 116, 118 based on the expected cycles of changing casters 106 between the respective caster sockets 116, 118.

As shown in FIG. 5B, a distance d₁ can be defined between the rear side 102D of the deck 102 and a center of the first caster socket 116 positioned closest to the rear side 102D of the deck 102. Additionally, a distance d₂ can be defined between a center of the stem 106A of one of the casters 106 and an outer surface of a wheel 106C of the same caster 106. According to an embodiment, the distance d₁ is substantially the same as the distance d₂.

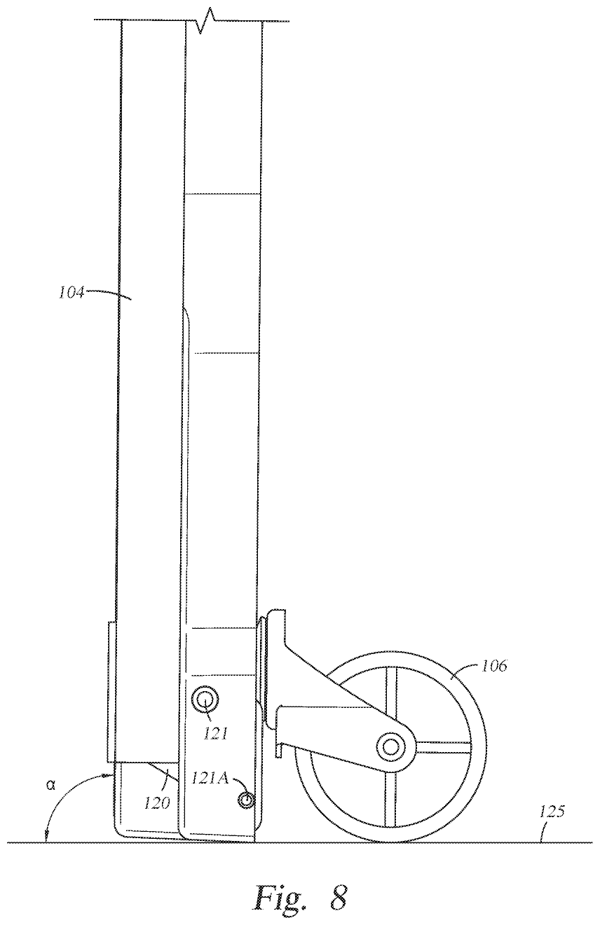

As can be seen in FIG. 8, this arrangement (d₁ being substantially equal to d₂) allows the platform cart to be stored upright in a zero-tilt position with the casters 106 positioned in the first caster socket. That is, a line between the rear side 102D and the outer surface of the wheel 106C forms an angle α—which is a substantially right angle—with the upper surface 110 of the deck 102, which allows the platform cart 100 to be stably stored in a substantially vertical position on an external surface 125, with the handle 104 in the fold-flat configuration without external support. When the platform cart 100 is in the substantially vertical position, the rear side 102D and the casters 106 provide sufficient support, so that the platform cart 100 is not susceptible to tipping. Accordingly, the platform cart 100 can be easily and safely stored in the vertical position.

Each of the casters 106 may be pivoting casters in which an axle of the wheel of the caster 106 is offset from the axis of the caster stem 106A. The wheel of the caster may have a generally flat outer circumference. The width of the generally flat outer circumference may provide a sufficiently stable area of contact with a supporting surface when the platform cart is resting in the vertical position so that the casters 106 do not pivot while providing support. That is, the casters 106 may provide a locally stable support for the platform cart 100 in the vertical position, even if the casters 106 are offset, pivoting casters.

Alternatively, two of the casters 106 may be non-pivoting casters, or they may be selectively lockable so as to pivot or not pivot. The non-pivoting or selectively lockable casters 106 may be used in the first caster sockets 116 located closest to the rear side 102D of the deck 102 to provide support in the vertical position.

The second caster sockets 118 are oriented in a direction parallel to the plane generally defined by the lower surface 112. As shown in, for example, FIGS. 5A, 5B, the second caster sockets 118 are oriented in a direction from the front side 102C to the rear side 102D (or vice versa). However, the present disclosure is not to be limited thereby, and it is contemplated that the second caster sockets 118 could be oriented in any direction parallel to the plane generally defined by the lower surface 112. Additionally, the second caster sockets 118 are each positioned within a pocket 122 (indicated in FIG. 5C) below the plane generally defined by the lower surface 112. As shown in FIGS. 5A, 5B, the stem 106A of each caster 106 can be inserted into a corresponding one of the second caster sockets 118 so that the casters 106 are secured within the pockets 122 and do not extend out of the lower surface 112. This flat-storage configuration shown for example, in FIGS. 5A and 5B (i.e., with the casters 106 positioned in the second caster sockets 118 and the handle in the fold-flat configuration) provides an even lower profile for storage compared to the casters 106 being positioned in the first caster sockets 116.

The second caster sockets 118 may, for example, each include a pair of coordinating flexible jaws 118A biased to a closed position. To insert a caster 106 into one of the second caster sockets 118, the user can press the stem 106A of the caster 106 between the jaws 118A, which then flex outwardly until the caster 106 is seated in the second caster socket 118. When the caster 106 is seated in the second caster socket 118, the jaws 118A close around the stem 106A, thereby securing the caster 106 in place. The caster 106 can be removed from the second caster socket 118 in reverse fashion.

As described above, the flat-storage configuration of the platform cart 100 shown in FIGS. 5A, 5B allows for an alternative storage solution compared to storing the platform cart 100 in the zero-tilt position shown in FIG. 8. Thus, the user is provided with different options for storage, depending on, for example, available storage space and/or use frequency. Furthermore, the user need not be concerned with losing any of the casters 106 when removed from the first caster sockets 114, because the second caster sockets 116 provide for convenient storage of the casters 106.

In addition, the flat-storage configuration of the platform cart 100 shown in FIGS. 5A, 5B is convenient for transport of the platform cart 100 from a manufacturing facility to a retailer, and for display of the platform cart 100 by the retailer. That is, the thickness (between upper surface 110 and lower surface 112) and width (between first side 102A and second side 102B) dimensions of the platform cart 100 in the flat-storage configuration are generally the same as the deck 102 taken separately. In the illustrated embodiment, the platform cart 100 in the flat-storage configuration has a slightly longer length (between the front and rear sides 102C, 102D) compared to the deck 102 taken separately, due to the handle 104 extending past the front side 102C. According to an alternate embodiment (not shown) a channel may be formed in the front side 102C to accommodate the handle 104, similar to the channels 102E formed in the first and second sides 102A, 102B. In any case, the width (between first and second sides 102A, 1022B) and the thickness (between upper and lower surfaces 110, 112) of the platform cart 100 in the flat-storage configuration are essentially the same as that of the deck 102 taken separately. Accordingly, multiple platform carts 100 can be compactly stored for transport and/or for display on a retail shelf.

As can be seen in, for example, FIGS. 4B, 5B, the handle 104 extends well beyond the front side 102C when the handle 104 is in the flat fold configuration. According to some embodiments, the length of the handle 104 is significantly longer than the overall length of the deck 102. According to such embodiments, the deck 102 may be relatively compact in length to accommodate, for example, household items, but not necessarily overly long items as might be required in some commercial applications. In some embodiments, such a compact deck 102 is provided, and the effective length of the handle is still sufficiently long enough so as to be ergonomic for pushing and pulling in the push and pull positions shown in FIG. 7.

For example, with reference to FIG. 4B, the effective length L1 of the handle from primary pin 121 to the front of the handle may be longer by about 15% or more than a corresponding length L2 from the primary pin 121 to the front of the deck 102. Accordingly, some embodiments of the present disclosure provide for a compact, consumer-grade platform cart 100 that is useful for household tasks while still providing a sufficiently long handle that can be used to ergonomically push or pull the platform cart 100.

Furthermore, the platform cart 100 may be packaged with packaging material, such as, for example, shrink wrap and/or printed materials for appropriate retail display. As an example, the packaging material may be wrapped around the central portion of the platform cart in the flat storage configuration. In such a case, the packaging material may enclose the pockets 122 having the casters 106 inserted into the second caster sockets 118, thereby minimizing a potential for the casters 106 to become displaced from the packaged platform cart 100. The packaging material may also enclose the lifting points 124A, 124B. The lifting point 124C may remain uncovered by the packaging material, thereby allowing the packaged platform cart 100 to be carried or otherwise supported by the lifting point 124C with the packaging material in place.

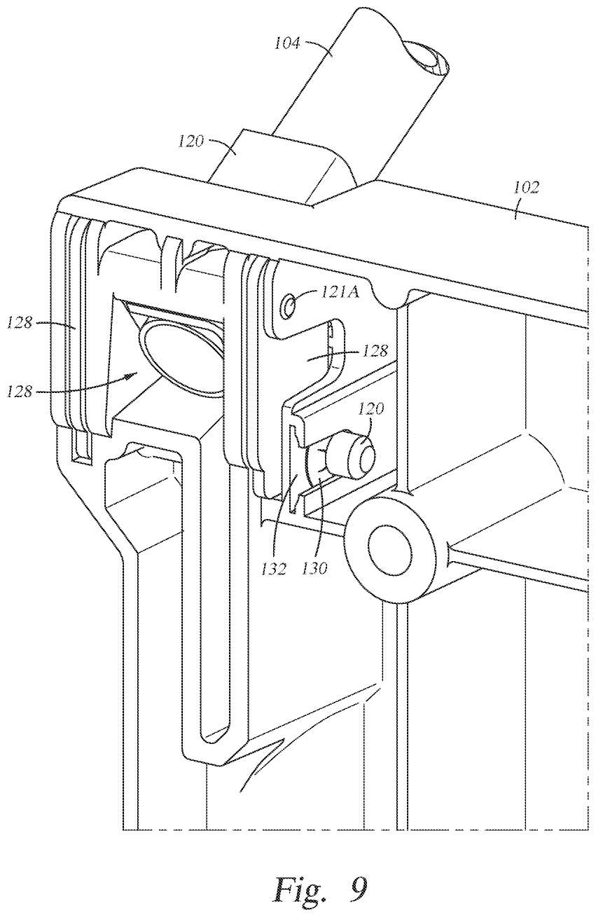

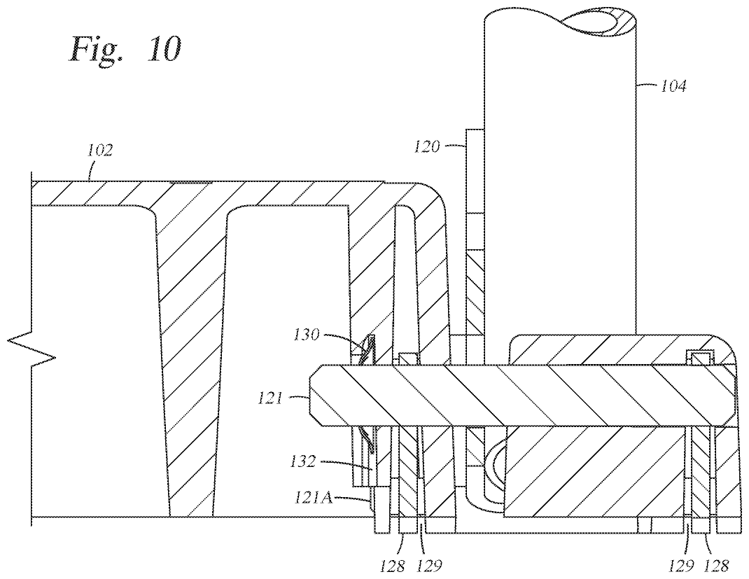

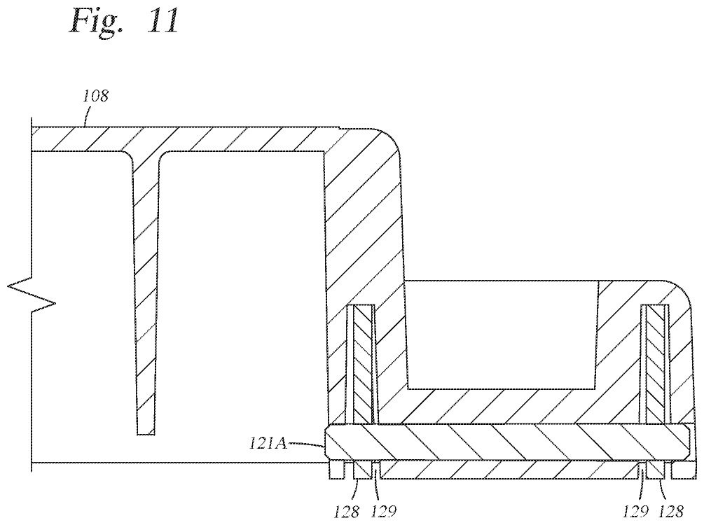

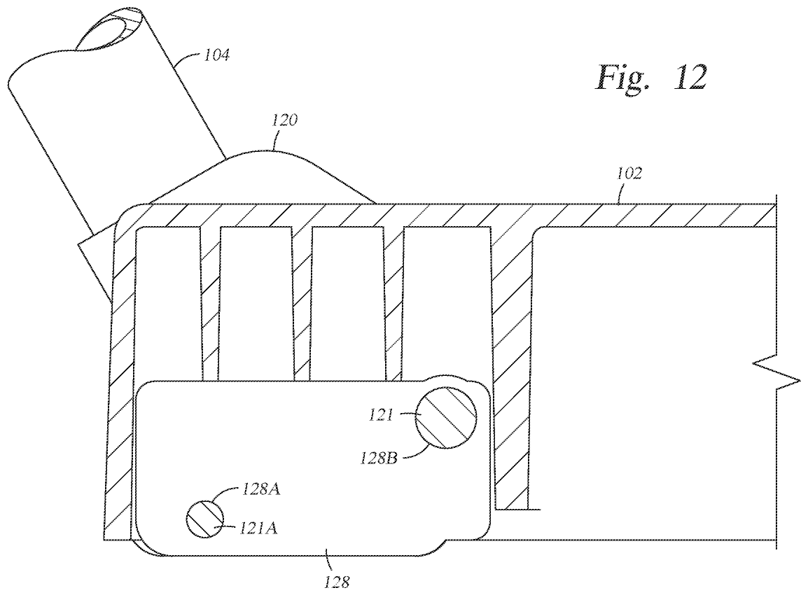

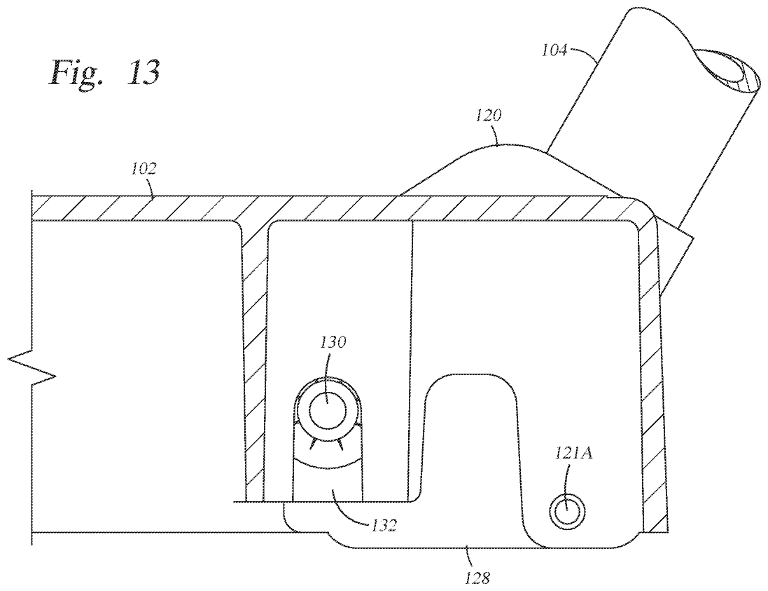

FIG. 9 is a detail perspective view of the lower surface 112 of the platform cart, illustrating the connection arrangement of the handle 104 to the deck 102. FIG. 10 is a cross-section view of the connection arrangement taken from the line indicated in FIG. 5B (but with the handle in the pull position rather than the fold-flat position shown in FIG. 5B). FIG. 11 is another cross-section view of the connection arrangement taken from the line indicated in FIG. 5B (again, with the handle in the pull position rather than the fold-flat position shown in FIG. 5B). FIG. 12 is another cross-section view of the connection arrangement taken from the line indicated in FIG. 5B (with the handle 104 and bracket 120 omitted). FIG. 13 is another cross-section view of the connection arrangement taken from the line indicated in FIG. 5B (with the handle in the pull position rather than the fold-flat position shown in FIG. 5B).

According to an embodiment, it may be desirable to provide reinforcing structure to account for high load forces that may be applied to the handle 104 and thus transferred to a relatively small portion of the deck 102. Accordingly, on exterior sides of each aperture 126, a pair of reinforcing plates 128 may be provided. Each reinforcing plate 128 is disposed in a respective plate slot 129 formed in the lower surface 112 of the deck 102. Each reinforcing plate 128 includes a retaining pin aperture 128A and a primary pin aperture 128B. The primary pin 121 extends through an aperture in the side (first side 102A or second side 102B) of the deck 102, through the primary pin aperture 128B of one reinforcing plate 128, through slot 120A in bracket 120, and through the primary pin aperture 128B of the other reinforcing plate 128 so that an end of the primary pin 121 protrudes into the retaining slot 132. A friction washer 130 positioned in the retaining slot 132 secures the end of the primary pin 121 in place. The other end of the primary pin 121 may be secured by a tight friction fit in the aperture in the side (first side 102A or second side 102b) of the deck 102.

The retaining pin 121A similarly extends through an aperture in the side (first side 102A or second side 102B) of the deck 102, through the secondary pin aperture 128A of one reinforcing plate 128, and through the secondary pin aperture 128A of the other reinforcing plate 128. The retaining pin 121A may be secured by a tight friction fit on both ends. Accordingly, the retaining pin 121A helps secure the reinforcing plates 128 in place relative to the deck 102, while the handle 104 is allowed to pivot about primary pin 121 as described above. Accordingly, loads (i.e., forces) applied to the primary pin 121 via the handle 104 can be at least partially received by the reinforcing plates 128, which may prevent breakage of the sides of the aperture 126 that might otherwise occur due to such loads.

While the foregoing is directed to embodiments of the present disclosure, other and further embodiments of the disclosure may be devised without departing from the basic scope thereof, and the scope thereof is determined by the claims that follow.

What is claimed is:

1. A platform cart, comprising:
a deck having a first plurality of caster sockets and a second plurality of caster sockets formed in a lower surface thereof;
a handle pivotally attached to the deck; and
a plurality of casters, each caster being selectively positionable in one of the first plurality of caster sockets and in one of the second plurality of caster sockets, wherein:
when each of the plurality of casters are respectively positioned in each of the first plurality of caster sockets, the plurality of casters extend from the lower surface of the deck to provide rolling support for the platform cart, and
when each of the plurality of casters are respectively positioned in each of the second plurality of caster sockets, the plurality of casters do not extend from the lower surface of the deck.

2. The platform cart according to claim 1, wherein:
when each of the plurality of casters are respectively positioned in each of the first plurality of caster sockets, a stem of each of the plurality of casters is oriented parallel to the lower surface of the deck.

3. The platform cart according to claim 1, wherein the deck includes a first recess in a first side of the deck, a second recess in a second side of the deck opposite the first side, and a third recess in a front side of the deck.

4. The platform cart according to claim 3, wherein the handle is configured to pivot relative to the deck between a fold-flat position and at least one of a push position and a pull position.

5. The platform cart according to claim 4, wherein:
when the handle is in the fold flat position:
the handle spans the first recess to provide a first carrying point,
the handle spans the second recess to provide a second carrying point, and
the handle spans the third recess to provide a third carrying point.

6. The platform cart according to claim 5, wherein:
when the handle is in the fold flat position and when each of the plurality of casters are respectively positioned in each of the second plurality of caster sockets, a thickness of the entire platform cart is substantially the same as a thickness of the deck taken separately.

7. The platform cart according to claim 1, wherein:
when each of the plurality of casters are respectively positioned in each of the first plurality of caster sockets, a line between a rear side of the deck and an outer circumference of a wheel of one or more of the casters closest to the rear side forms a substantially right angle with an upper surface of the deck opposite the lower surface.

8. The platform cart according to claim 7, wherein:
the handle is configured to pivot relative to the deck between a fold-flat position and at least one of a push position and a pull position, and
when each of the plurality of casters are respectively positioned in each of the first plurality of caster sockets and the handle is in the fold flat position, the platform cart can be stably stored in a substantially vertical position on an external surface, wherein:
when the platform cart is stored in the substantially vertical position, the rear side of the deck and the outer circumference of the wheel of the one or more of the casters closest to the rear side support the platform cart in the substantially vertical position.

9. The platform cart according to claim 1, wherein the plurality of casters can each be positioned and removed from each of the first plurality of caster sockets and each of the second plurality of caster sockets by a user without tools.

10. A platform cart comprising:
a deck having a first plurality of caster sockets and a second plurality of caster sockets formed in a lower surface thereof;
a handle pivotally attached to the deck;
a reinforcing plate positioned at a pivot point where the handle pivots relative to the deck, the reinforcing plate configured to reinforce the deck from breakage due to force applied to the handle; and
a plurality of casters, each caster being selectively positionable in one of the first plurality of caster sockets and in one of the second plurality of caster sockets.

11. The platform cart according to claim 10, wherein:
the handle is pivotally attached to the deck with a primary pin, and
the reinforcing plate is disposed in a slot formed in the deck and is secured to the deck with the primary pin and a retaining pin.

12. A platform cart, comprising:
a deck having a first plurality of caster sockets and a second plurality of caster sockets formed in a lower surface thereof;
a handle pivotally attached to the deck with a pivot pin; and
a plurality of casters, each caster being selectively positionable in one of the first plurality of caster sockets and in one of the second plurality of caster sockets, wherein:
an effective length of the handle from the pivot pin to a front end of the handle is longer by about 15% or more than a corresponding length of the deck from the pivot pin to a front side of the deck.

13. A platform cart, comprising:
a deck having a first plurality of caster sockets and a second plurality of caster sockets formed in a lower surface thereof;
a handle pivotally attached to the deck;
a plurality of casters, each caster being selectively positionable in one of the first plurality of caster sockets and in one of the second plurality of caster sockets, wherein:
when each of the plurality of casters are respectively positioned in each of the first plurality of caster sockets, a line between a rear side of the deck and an outer circumference of a wheel of one or more of the casters closest to the rear side forms a substantially right angle with an upper surface of the deck opposite the lower surface.

14. The platform cart according to claim 13, the handle is configured to pivot relative to the deck between a fold-flat position and at least one of a push position and a pull position, and
when each of the plurality of casters are respectively positioned in each of the first plurality of caster sockets and the handle is in the fold flat position, the platform cart can be stably stored in a substantially vertical position on an external surface.

15. The platform cart according to claim 13, wherein each of the plurality of casters are pivoting casters.

16. The platform cart according to claim 13, wherein,
when the platform cart is stored in the substantially vertical position, the rear side of the deck and the outer circumference of the wheel of the one or more of the casters closest to the rear side support the platform cart in the substantially vertical position.

17. The platform cart according to claim 13, wherein:
when each of the plurality of casters are respectively positioned in each of the first plurality of caster sockets, a stem of each of the plurality of casters is oriented parallel to the lower surface of the deck.

18. The platform cart according to claim 13, wherein the deck includes a first recess in a first side of the deck, a second recess in a second side of the deck opposite the first side, and a third recess in a front side of the deck.

19. The platform cart according to claim 18, wherein the handle is configured to pivot relative to the deck between a fold-flat position and at least one of a push position and a pull position.

20. The platform cart according to claim 19, wherein:
when the handle is in the fold flat position:
the handle spans the first recess to provide a first carrying point,
the handle spans the second recess to provide a second carrying point, and
the handle spans the third recess to provide a third carrying point.
